(19) United States
(12) Patent Application Publication
(10) Pub. No.: US 2019/0025247 A1
(43) Pub. Date: Jan. 24, 2019

(54) Carbon nanotube forest strain sensor and the forming method thereof

(71) Applicant: National Taiwan University, Taipei (TW)

(72) Inventors: Shuo-Hung CHANG, Taipei City (TW); Chih-Chung SU, Taipei City (TW); Kuan-Yu YEH, Taipei City (TW)

(21) Appl. No.: 15/657,258

(22) Filed: Jul. 24, 2017

(51) Int. Cl. G01N 27/416

(52) U.S. Cl. CPC G01N 27/416

(57) ABSTRACT

The present invention is a highly sensitive and flexible carbon nanotube forest strain sensor, comprising: a first electrode, a second electrode, a same directory queue carbon nanotube forest, and a flexible support substrate. The present invention provides a method for manufacturing a carbon nanotube forest strain sensor, the same directory queue carbon nanotube forest can be directly grown on a flexible support substrate by a chemical vapor deposition method.

### BACKGROUND OF THE INVENTION

### 1. Field of the Invention

The present invention relates to a carbon nanotube forest strain sensor and the forming method thereof, particularly to a highly sensitive and flexible carbon nanotube forest strain sensor and the forming method thereof.

### 2. Description of the Prior Art

Nowadays, the conventional “strain sensor” is made up of the metal film (or membrane). However, its “gauge factor” is only up to 1 to 5 (when the gauge factor is the greater, the sensitivity of measurement will be the higher). The “gauge factor” of some strain sensors made by the semiconductor technology is higher sensitivity, which is reached to 15 to 200. However, except the semiconductor technology needs to use much expensive instruments in order to induce very high cost, the base substrate of “gauge factor” is silicon, which is not hard and brittle, but also with the high manufacturing cost and the limited processing technology, which limits the technological development of “gauge factor”greatly.

As the carbon nanotube is quite hot sensing material in the recent years, the carbon nanotube utilizes the semiconductor technology to make the strain sensor. The “gauge factor” of this strain sensor can be up to more than 1000, but if the silicon substrate is used, the development of the strain sensor will be limited. In addition, the carbon nanotube forest strain sensor is made by the post-treatment in a lot of research fields, so that the manufacturing method is quite complicated, and the repeatability of manufacturing is also influenced.

In addition, the characteristics of “flexibility” is also the development demand of “strain sensor” in recent years. Because the “flexible strain sensor” has the characteristics of easy processing, easy integration, elastic design and simple manufacturing, which can reduce the complexity of elements manufacturing and can reduce the manufacturing cost of the “strain sensor”. However, because the “flexible” substrate is unable to bear high temperature, so that all most flexible “strain sensors” are made by the post-treatment, that is to say the sensing element and the sensing material are made separately. However, this manufacturing method will increase the manufacturing cost and influenced by the environment and manufacturing technology, so that the repeatability of manufacturing technology is unable to be improved.

Thus, in order to reduce the manufacturing cost of “strain sensor” and uninfluenced by the environment and manufacturing technology, and increase the repeatability of manufacturing technology, it is necessary to research and develop new “flexible strain sensor”, so as to increase the sensing efficiency of “strain sensor”, and educe the whole manufacturing cost of “strain sensor”.

### SUMMARY OF THE INVENTION

The present invention is a highly sensitive and flexible carbon nanotube forest strain sensor, comprising: a first electrode, a second electrode, a same directory queue carbon nanotube forest, and a flexible support substrate. The first electrode and the second electrode are set above the same directory queue carbon nanotube forest, and there is a suitable distance between the first electrode and the second electrode.

The same directory queue carbon nanotube forest of the carbon nanotube forest strain sensor of the present invention can be directly (or indirectly) grown on a flexible support substrate.

The flexible support substrate of the carbon nanotube forest strain sensor of the present invention comprises a soft material which can bear the temperature up to 600° C., a soft material which cannot bear the temperature up to 600° C.

When a uniform voltage is applied to both sides of the carbon nanotube forest of the carbon nanotube forest strain sensor of the present invention, a high resistance change rate can be produced for the flexible carbon nanotube forest strain sensor at the small external deformation.

The present invention provides a simple method for manufacturing a carbon nanotube forest strain sensor, the same directory queue carbon nanotube forest can be directly grown on a flexible support substrate by a chemical vapor deposition (CVD) method.

The present invention is a highly sensitive and flexible carbon nanotube forest strain sensor and the forming method thereof. The same directory queue carbon nanotube forest can be used to manufacture a highly sensitive and flexible carbon nanotube forest strain sensor, so that a high resistance change rate can be produced for the flexible carbon nanotube forest strain sensor at the small strain and the voltage input, which can be used on various objects to be sensed.

The present invention relates to a sensing method of the highly sensitive and flexible carbon nanotube forest strain sensor, comprising the following steps: providing an object to be sensed, this object can be a point, a line or a plan, then, put the highly sensitive and flexible carbon nanotube forest strain sensor of the present invention on the object to be sensed, apply a small voltage to both electrodes of the carbon nanotube forest strain sensor, when the object to be sensed received a small strain, a small deformation will be produced on the flexible support substrate, and a high resistance change rate will be produced on the flexible carbon nanotube forest strain sensor to achieve the goal of straining the object to be sensed.

Comparing to the prior art, the present invention is a highly sensitive and flexible carbon nanotube forest strain sensor and the forming method thereof, which has the following advantages:

Firstly, the present invention can be manufactured by a chemical vapor deposition method, a same directory queue carbon nanotube forest can be synthesized. Any small-area or large-area element can be manufactured, and a uniform sensing sensitivity can be produced, so that it is suitable for applying to various objects to be sensed.

Secondly, when a small strain is received by the carbon nanotube forest of the present invention, a resistance change can be produced on the contact area at the side wall of carbon nanotube, which can correspond to ten millions of carbon nanotubes to produce the high resistance change rate. So that it will be higher sensitivity.

Thirdly, the same directory queue carbon nanotube forest of the carbon nanotube forest strain sensor of the present invention can be directly (or indirectly) grown on and transferred to a flexible support substrate. So that the structure of sensor is simple, which is suitable for various flexible substrates and various objects to be sensed. The invention can reduce the restriction of the substrate, and increase utilization and value significantly.

Fourthly, in the same directory queue carbon nanotube forest, because there are iron particles (or iron nano-lines) in the carbon nanotube, the hindrance of electron transmission is increased, so that the resistance change rate is large, the resistance in increased, and the sensing sensitivity is also increased.

Fifthly, the synthesis method for the same directory queue carbon nanotube forest of the present invention is simple, only needs to utilize the ferrocene (or iron membrane) as the catalyst in the acetylene, ethylene, hydrogen, and hydrogen for growing. The invention can save the manufacturing time and cost.

Sixthly, a carbon nanotube forest strain sensor can be grown on a flexible support substrate. Because the process temperature is higher than 600° C., the invention is suitable for the strain sensing in the high-temperature environment, which can increases the application in various environments significantly.

As for other advantages of the present invention, the present invention has the high gauge factor, the high sensing sensitivity and the high sensing efficiency etc.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the side stereo view of the “carbon nanotube forest strain sensor” of the present invention.

FIG. 2 illustrates the side cross-sectional view of the “carbon nanotube forest strain sensor” of the present invention.

FIG. 3 illustrates the side stereo view of the “carbon nanotube forest strain sensor” with the encapsulation layer of the present invention.

FIG. 4 illustrates a method for manufacturing a highly sensitive and flexible “carbon nanotube forest strain sensor” of the present invention.

FIG. 5 illustrates a method for manufacturing a highly sensitive and flexible “carbon nanotube forest strain sensor” with the encapsulation layer of the present invention.

FIG. 6 illustrates the electron microscopic diagram of the “carbon nanotube forest” growing on a flexible “support substrate” of the present invention.

FIG. 7 illustrates the electron microscopic diagram of the “carbon nanotube forest” growing on a flexible “support substrate” of the present invention.

FIG. 8 illustrates the strain/resistance change rate diagram of the present invention.

### DESCRIPTION OF THE PREFERRED EMBODIMENT

In order to understand the present invention thoroughly, the detailed steps and components will be presented in the following description. However, as for the better embodiments of the present invention, they will be described as follows in detail. However, excepts these detailed description, the present invention can also be widely implemented in other embodiments. The range of the present invention is not limited, and is subject to the subsequent patent scope.

The implementation of the present invention will be described with the figures in the following description, the manufacturing method of the “carbon nanotube forest strain sensor”, and the method of sensing the strained object.

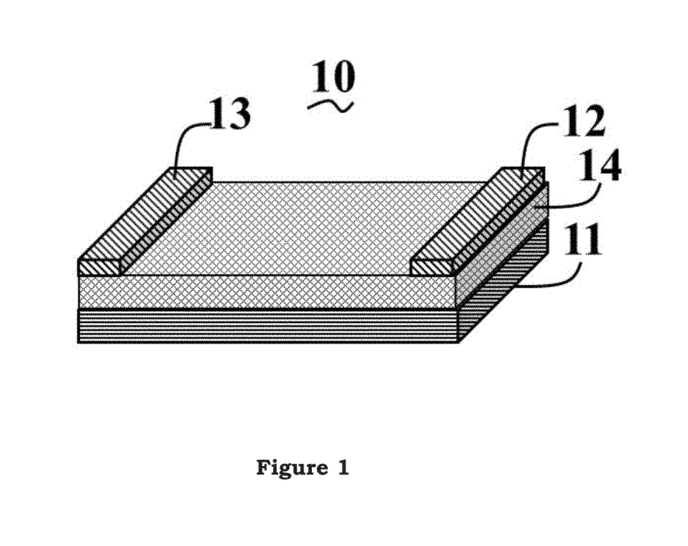

The present invention is a highly sensitive and flexible “carbon nanotube forest strain sensor 10”. Please refer to FIG. 1 for the side stereo view of the “carbon nanotube forest strain sensor 10” of the present invention. The “carbon nanotube forest strain sensor 10” comprises a “first electrode 12”, a “second electrode 13”, a same directory queue “carbon nanotube forest 14”, and a “flexible support substrate 11”. The “first electrode 12” and the “second electrode 13” are set above the same directory queue “carbon nanotube forest 14”, and there is a specific distance between the “first electrode 12” and the “second electrode 13”. The same directory queue “carbon nanotube forest 14” can be directly (or indirectly) grown (set or transferred) on the “flexible support substrate 11”.

Please refer to FIG. 1 for the side stereo view of the “carbon nanotube forest strain sensor 10” of the present invention. As for further description of the same directory queue “carbon nanotube forest 14”, every iron-filled (or iron-unfilled) carbon nanotube is the same directory queue and grows uniformly and vertically on the “flexible support substrate 11” which can bear the temperature up to 600° C. The height of the same directory queue “carbon nanotube forest 14” can be adjusted in accordance with different grown height of the same directory queue “carbon nanotube forest 14”. The tube diameter of every iron-filled (or iron-unfilled) carbon nanotube is between 5 nanometers (nm) and 20 nm. The iron in the carbon nanotube can be iron particle, or iron nano-line, or other metal particle. Every carbon nanotube of the same directory queue “carbon nanotube forest 14” is arranged to the same directory queue.

Please refer to FIG. 1 for the side stereo view of the “carbon nanotube forest strain sensor 10” of the present invention. When a small and stable voltage is applied to the flexible “carbon nanotube forest strain sensor 10”, a strain will be produced by a mall external force. The area of side wall of carbon nanotube in the “carbon nanotube forest 14” on the “flexible support substrate 11” will be changed due to the strain, and the resistance change rate will become larger. So that the “carbon nanotube forest strain sensor 10” of the present invention can produce high resistance change rate at small strain, and can obtain excellent strain sensing sensitivity.

Please refer to FIG. 1 for the side stereo view of the “carbon nanotube forest strain sensor 10” of the present invention. In addition, the conductive materials of abovementioned “first electrode 12” and “second electrode 13” are not limited, which can be gold, silver, copper, aluminum, indium tin oxide (ITO), and carbon nanotube etc. The adhesive material of the “first electrode 12” and the “second electrode 13” can be the “metal silver glue”. The metal sheet, coating or electroplating can also be used, and there are no limitations on shapes made. There are no limitations for the materials of abovementioned “first electrode 12” and “second electrode 13”, but it is better to use the “metal silver glue” in the embodiment of the present invention.

Please refer to FIG. 1 for the side stereo view of the “carbon nanotube forest strain sensor 10” of the present invention. The abovementioned “first electrode 12” and “second electrode 13” are set above the same directory queue “carbon nanotube forest 14”. There is a suitable distance between the “first electrode 12” and the “second electrode 13”, in order to prevent the short circuit upon applying the current. The “first electrode 12” and the “second electrode 13” can contact the top surface of “carbon nanotube forest 14” but cannot contact the “flexible support substrate 11”.

Please refer to FIG. 1 for the side stereo view of the “carbon nanotube forest strain sensor 10” of the present invention. The material of “flexible support substrate 11” can be a “soft material which can bear the temperature up to 600° C.”, or a “soft material which cannot bear the temperature up to 600° C”. In which the “soft material which can bear the temperature up to 600° C.” comprises the “aluminum foil”, “copper foil”, and “stainless steel foil” etc. The same directory queue “carbon nanotube forest 14” can be directly grown up. As for the “soft material which cannot bear the temperature up to 600° C.” an additional layer of adhesive shall be applied. The adhesive can be conductive or nonconductive, which is used to transfer the grown same directory queue “carbon nanotube forest 14” onto the soft material. In addition, the grown same directory queue “carbon nanotube forest 14” can be directly transferred to the sticky tape. The “flexible support substrate 11” used in the present invention is a flexible “aluminum foil”, the same directory queue “carbon nanotube forest 14” can be directly grown on the flexible “aluminum foil”.

Please refer to FIG. 1 for the side stereo view of the “carbon nanotube forest strain sensor 10” of the present invention. The “flexible support substrate 11” is an sticky “tape” which is not heat-resistant (such as the temperature up to 600° C.). The sticky “tape” can be directly stuck to the same directory queue carbon nanotube forest 14 on the “flexible support substrate 11”. The same directory queue “carbon nanotube forest 14” will be directly transferred to the “tape”. Two electrodes are placed on the same directory queue “carbon nanotube forest 14” transferred through the “tape”, in order to manufacture the highly sensitive and flexible “carbon nanotube forest strain sensor 10” of the present invention.

Please refer to FIG. 1 for the side stereo view of the “carbon nanotube forest strain sensor 10” of the present invention. Wherein, the “carbon nanotube forest strain sensor 10” can be exposed in the atmosphere or encapsulated in the inert gas. The embodiment of the present invention can be exposed in the atmosphere. When a 0.1V power is applied to the highly sensitive and flexible “carbon nanotube forest strain sensor 10”, the gauge factor of the highly sensitive and flexible “carbon nanotube forest strain sensor 10” can be up to 260 to 300.

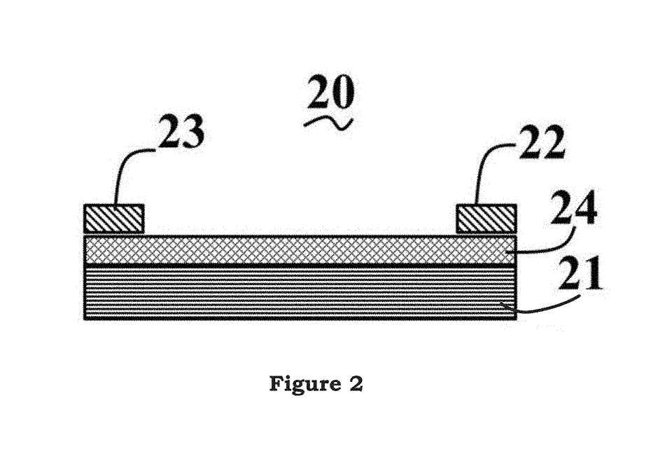

Please refer to FIG. 2 for the side cross-sectional view of the “carbon nanotube forest strain sensor 20” of the present invention. The “carbon nanotube forest strain sensor 20” includes a “first electrode 22”, a “second electrode 23”, a same directory queue “carbon nanotube forest 24”, and a “flexible support substrate 21”. The “first electrode 22” and the “second electrode 23” are set above the same directory queue “carbon nanotube forest 24”, and there is a specific distance between the “first electrode 22” and the “second electrode 23”. The same directory queue “carbon nanotube forest 24” can be directly (or indirectly) grown (set or transferred) on the “flexible support substrate 21”.

Please refer to FIG. 1 for the side stereo view of the “carbon nanotube forest strain sensor 10” of the present invention and FIG. 2 for the side cross-sectional view of the “carbon nanotube forest strain sensor 20” of the present invention. In an embodiment of the present invention, the area of the same directory queue “carbon nanotube forest 14” or “carbon nanotube forest 24” is 0.2 cm² to 0.8 cm². The power can be applied to the electrode of the same directory queue “carbon nanotube forest 14” to obtain the highly sensitive and flexible “carbon nanotube forest strain sensor 10”.

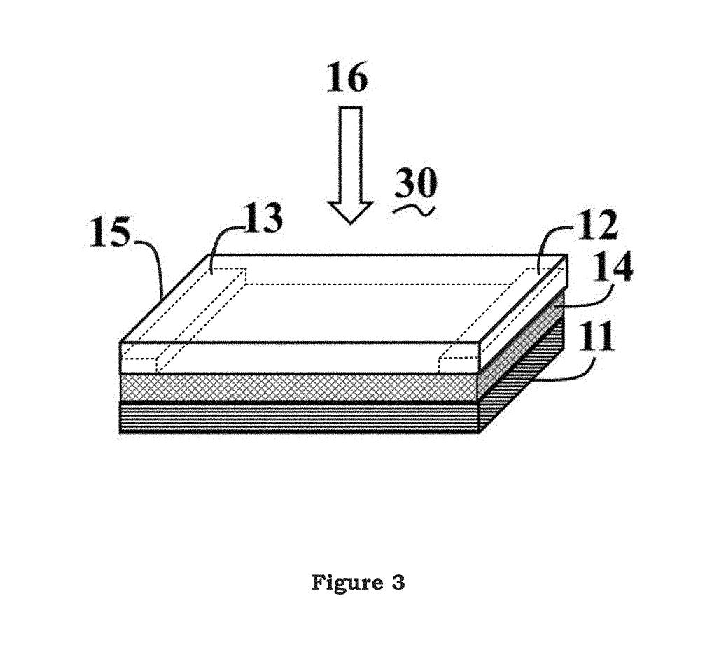

Please refer to FIG. 3 for the side stereo view of the “carbon nanotube forest strain sensor” with the encapsulation layer of the present invention. In an embodiment of the present invention, the “carbon nanotube forest 14” is grown on the “aluminum foil”, which can be transferred to various “flexible support substrate 11”. So that the shape of “flexible support substrate 11” can comprise the curved surface, and uneven structure for the protection. If the “flexible support substrate 11” is not heat-resistant (such as the temperature up to 600° C.), the transferred step shall be conducted. If the “flexible support substrate 11.” is not heat-resistant (such as the temperature up to 600° C.), the material may be sticky or not sticky material. If the material is not sticky, a layer of adhesive shall be applied onto the substrate of not sticky material. The adhesive can be conductive or nonconductive. The grown same directory queue “carbon nanotube forest 14” is placed on the adhesive. After the adhesive is hardened, the “flexible support substrate 11” can be taken out easily. Finally, the conductive material is fixed on the transferred same directory queue “carbon nanotube forest 14”, and a “protection encapsulation layer 15” is covered at a suitable distance. The “first electrode 12”, the “second electrode 13”, and the same directory queue “carbon nanotube forest 14” are covered by the “protection encapsulation layer 15”, in order to form the highly sensitive and flexible “carbon nanotube forest strain sensor 10” with the “protection encapsulation layer 15” of the present invention.

Please refer to FIG. 3 for the side stereo view of the “carbon nanotube forest strain sensor” with the encapsulation layer of the present invention. A “pre-force 16” can be applied to the present invention. After the “carbon nanotube forest 14” receives the pre-force 16, it will bend down to increase the contact points of the carbon nanotube forest, and increase the resistance change rate. In which the “first electrode 12” and the “second electrode 13” shall contact the top surface of “carbon nanotube forest 14” but the “carbon nanotube forest 14” shall not contact the “flexible support substrate 11”, the flexible support substrate 1 “cannot contact the “first electrode 12” and the “second electrode 13”.

Please refer to FIG. 3 for the side stereo view of the “carbon nanotube forest strain sensor” with the encapsulation layer of the present invention. The “carbon nanotube forest 14” of the present invention can be directly (or indirectly) grown on the flexible “support substrate 11”. If the flexible “support substrate 11” can resist the temperature up to 600° C. The “first electrode 12” and the “second electrode 13” can be set above the same directory queue “carbon nanotube forest 14”, in order to complete the highly sensitive and flexible “carbon nanotube forest strain sensor 10”.

The present invention relates to a sensing method of the highly sensitive and flexible “carbon nanotube forest strain sensor 10” with the encapsulation layer, comprising the following steps: providing an object to be sensed, the object can be a point, a line or a plan, then, put the highly sensitive and flexible “carbon nanotube forest strain sensor 10” of the present invention on the object to be sensed, apply a small voltage to both electrodes of the “carbon nanotube forest strain sensor 10”, when the object to be sensed received a small “strain”, a small deformation will be produced on the “flexible support substrate 11”, and a high resistance change rate will be produced on the flexible “carbon nanotube forest strain sensor 14” to achieve the goal of straining the object to be sensed.

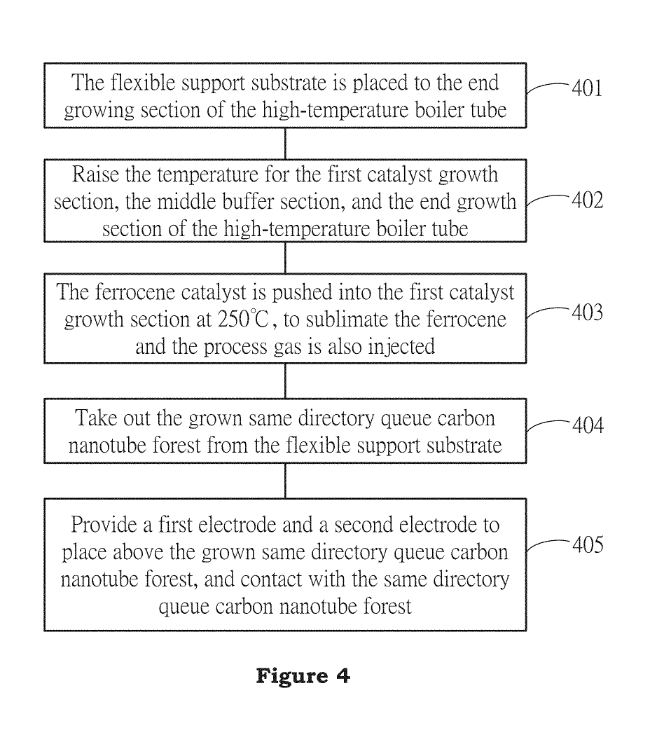

Please refer to FIG. 4 for a method for manufacturing a highly sensitive and flexible “carbon nanotube forest strain sensor” of the present invention. The steps are shown as follows:

At first, as shown in the step 401 of FIG. 4, a chemical vapor deposition (CVD) method can be used to place the flexible metal substrate (i.e. support substrate 11) which can bear the temperature up to 600° C. on a high-temperature boiler tube for conducting the chemical vapor deposition. The flexible metal substrate is any flexible metal substrate which can bear the temperature up to 600° C. The metal better flexible substrate in the present invention is the “aluminum foil”. In other words, the “aluminum foil” is placed in the “carbon nanotube forest 14” growing section of the high-temperature boiler tube. At this moment, the ferrocene is placed at the outside of the catalyst sublimation section first.

Then, as shown in the step 402 of FIG. 4, the argon carrier gas is injected. Under the environment of argon gas, raise the temperature for the first catalyst growth section, the middle buffer section, and the end growth section of the high-temperature boiler tube. At this moment, the ferrocene is still located at the outside of the catalyst sublimation section without heating.

Continuously, as shown in the step 403 of FIG. 4, the ferrocene catalyst is pushed into the first catalyst growth section at 250° C. The first catalyst growth section is heated to 650° C. in 20 minutes and the growth time is 10 minutes. The ferrocene will be sublimated and the process gas is also injected.

Following, as shown in the step 404 of FIG. 4, close the carrier (process) gas and leave the argon gas and cool to room temperature. Take out the grown same directory queue “carbon nanotube forest 14” from the flexible support substrate. The height of the same directory queue “carbon nanotube forest 14” will be between several nanometers to several hundred nanometers.

Finally, as shown in the step 405 of FIG. 4, provide a “first electrode 12” and a “second electrode 13” to place above the grown same directory queue “carbon nanotube forest 14”, and contact with the grown same directory queue “carbon nanotube forest 14”.

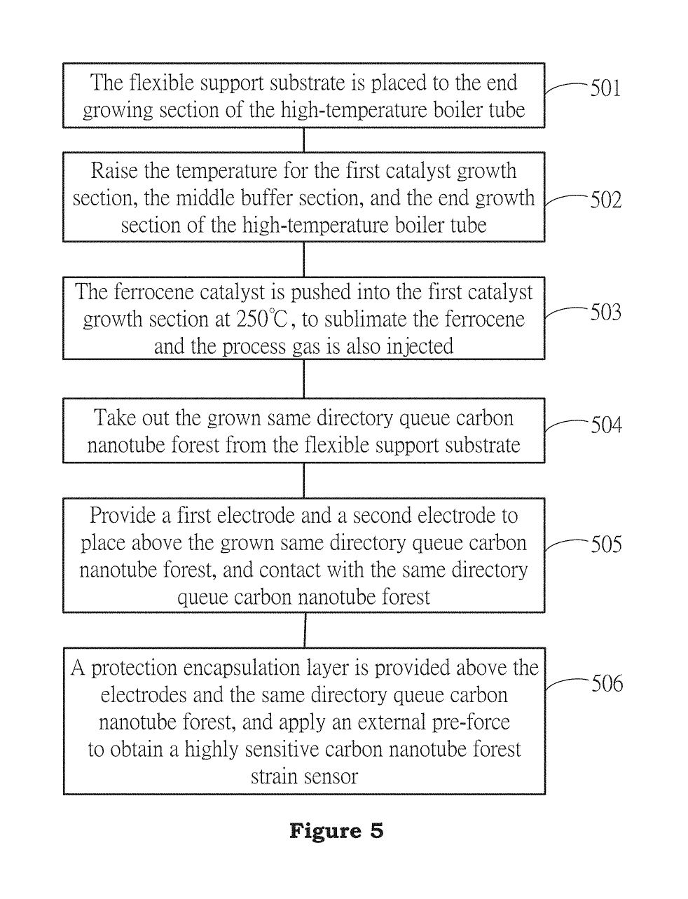

As shown in FIG. 5, in the method for manufacturing a highly sensitive and flexible “carbon nanotube forest strain sensor” with the encapsulation layer of the present invention, wherein the process gases are the carbon-containing gas and the “hydrogen gas”. In which the carbon-containing gas may be the “acetylene” or “ethylene” etc. However, the better carbon-containing gas used in the present invention is the “acetylene”. The “hydrogen gas” is used to reduce the defect of carbon nanotube. The “argon gas” is an insert gas, which is used to carry the sublimated ferrocene gas molecules.

Please refer to FIG. 5 for a method for manufacturing a highly sensitive and flexible “carbon nanotube forest strain sensor” with the encapsulation layer of the present invention. The steps are shown as follows:

At first, as shown in the step 501 of FIG. 5, a chemical vapor deposition (CVD) method can be used to place the flexible metal substrate (i.e. support substrate 11) which can bear the temperature up to 600° C. on a high-temperature boiler tube for conducting the chemical vapor deposition. The flexible metal substrate is any flexible metal substrate which can bear the temperature up to 600° C. The metal better flexible substrate in the present invention is the “aluminum foil”. In other words, the “aluminum foil” is placed in the “carbon nanotube forest 14” growing section of the high-temperature boiler tube. At this moment, the ferrocene is placed at the outside of the catalyst sublimation section first.

Then, as shown in the step 502 of FIG. 5, the argon carrier gas is injected. Under the environment of argon gas, raise the temperature for the first catalyst growth section, the middle buffer section, and the end growth section of the high-temperature boiler tube. At this moment, the ferrocene is still located at the outside of the catalyst sublimation section without heating.

Continuously, as shown in the step 503 of FIG. 5, the ferrocene catalyst is pushed into the first catalyst growth section at 250° C. The first catalyst growth section is heated to 650° C.; in 20 minutes and the growth time is 10 minutes. The ferrocene will be sublimated and the process gas is also injected.

Following, as shown in the step 504 of FIG. 5, close the carrier (process) gas and leave the argon gas and cool to room temperature. Take out the grown same directory queue “carbon nanotube forest 14” from the flexible support substrate. The height of the same directory queue “carbon nanotube forest 14” will be between several nanometers to several hundred nanometers.

And, as shown in the step 505 of FIG. 5, provide a “first electrode 12” and a “second electrode 13” are place above the grown same directory queue “carbon nanotube forest 14”, and contact with the grown same directory queue “carbon nanotube forest 14”.

And, as shown in the step 506 of FIG. 5, a “protection encapsulation layer 15” is provided above the “first electrode 12” and the “second electrode 13”. The “protection encapsulation layer 15” is the “tape 15”. An adhesive “tape 15” is used to encapsulate the “first electrode 12” and the “second electrode 13” on the same directory queue “carbon nanotube forest 14”. In other words, the “protection encapsulation layer 15” is used to package the “first electrode 12”, the “second electrode 13”, the same directory queue “carbon nanotube forest 14”, and the bottom back of the “flexible support substrate 11”. That is, “protection encapsulation layer 15” package and fix the upper and the bottom back of the “carbon nanotube forest strain sensor 10”, in order to produce the protecting effect.

As shown in FIG. 5, in the method for manufacturing a highly sensitive and flexible “carbon nanotube forest strain sensor” with the encapsulation layer of the present invention, wherein the process gases are the carbon-containing gas and the “hydrogen gas”. In which the carbon-containing gas may be the “acetylene” or “ethylene” etc. But the better carbon-containing gas used in the present invention is the “acetylene”. The “hydrogen gas” is used to reduce the defect of carbon nanotube. The “argon gas” is an insert gas, which is used to carry the sublimated ferrocene gas molecules.

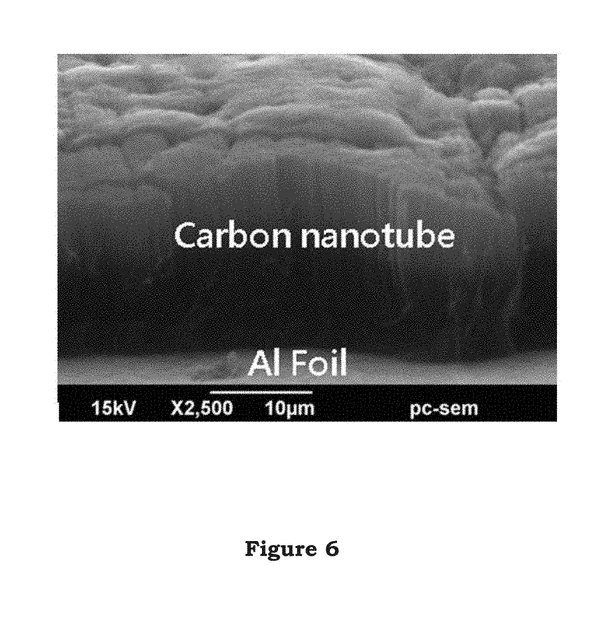

FIG. 6 relates to the scanning electron microscopic (SEM) diagram of the “carbon nanotube forest 14” growing on a “flexible support substrate 11” of the present invention, which is the SEM diagram of “carbon nanotube forest 14” growing on a “flexible Al foil”.

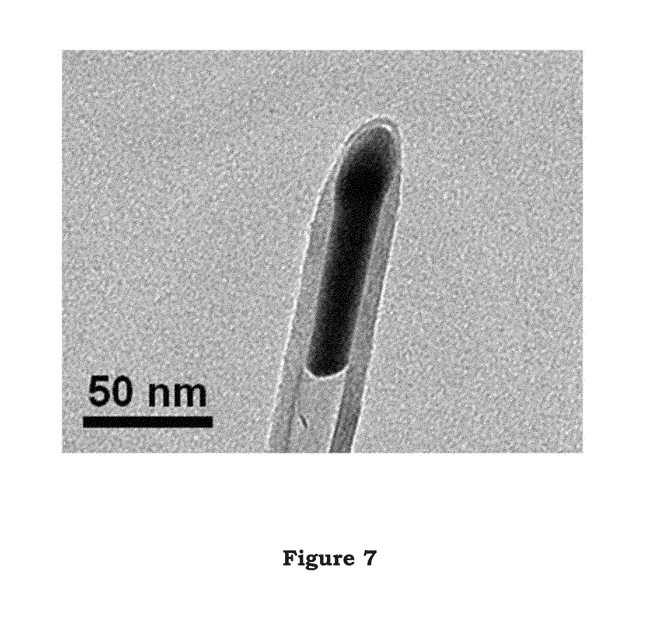

FIG. 7 relates to the scanning electron microscopic (SEM) diagram of the “carbon nanotube”. From the diagram, the size of a single “carbon nanotube” can be known. The size of a single “carbon nanotube” is not larger than 50 nanometers.

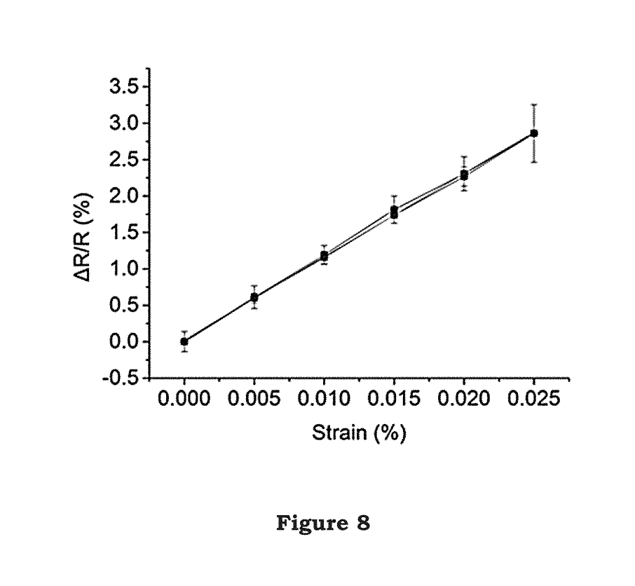

FIG. 8 relates to the strain/resistance change rate diagram of the present invention. When the present invention receives a small external force, a strain will be produced, as the “strain (%)” shown on the horizontal axis of FIG. 8. The contact area of side wall of carbon nanotube in the “carbon nanotube forest 14” on “flexible support substrate 11” will be changed due to the strain. So that the “resistance change rate R/R(%)” will become larger shown on the vertical axis of FIG. 8. There is the proportional relationship. So that the “carbon nanotube forest strain sensor 10” of the present invention can produce high resistance change rate at small strain, and can obtain excellent strain sensing sensitivity.

Comparing to the other sensors, the present invention has comprehensive advantages, such as high stability and high efficiency etc. The present invention can simplify the process steps to reduce the manufacturing cost significantly. In addition, the present invention has high gauge factor, high sensing sensitivity and high sensing efficiency etc.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed:

1. A carbon nanotube forest strain sensor, comprising:
a support substrate;
a first electrode;
a second electrode; and
a same directory queue carbon nanotube forest,
wherein the first electrode and the second electrode being set above the same directory queue carbon nanotube forest, and there is a suitable distance between the first electrode and the second electrode, the same directory queue carbon nanotube forest being grown on the support substrate.

2. A carbon nanotube forest strain sensor with the encapsulation layer, comprising:
a support substrate;
a first electrode;
a second electrode;
a same directory queue carbon nanotube forest; and
an encapsulation layer,
wherein the first electrode and the second electrode being set above the same directory queue carbon nanotube forest, and there is a suitable distance between the first electrode and the second electrode, the same directory queue carbon nanotube forest being grown on the support substrate, the encapsulation layer covering the first electrode, the second electrode, the carbon nanotube forest, and the bottom back of the flexible support substrate.

3. A method for manufacturing a carbon nanotube forest strain sensor, comprising:
placing a support substrate on a high-temperature boiler tube for conducting a chemical vapor deposition, a ferrocene is placed at an outside of a catalyst sublimation section;
injecting a carrier gas, under an environment of carrier gas, raise a temperature for a first catalyst growth section, a middle buffer section, and an end growth section of a high-temperature boiler tube;
pushing a ferrocene catalyst into a first catalyst growth section at a rising temperature, sublimating a ferrocene and injecting a process gas;
closing the carrier gas and leaving an argon gas and cooling to a room temperature, taking out a carbon nanotube forest; and
providing a first electrode and a second electrode to place above a grown same directory queue carbon nanotube forest, and contacting with a same directory queue carbon nanotube forest.

4. A method for manufacturing a carbon nanotube forest strain sensor with the encapsulation layer, comprising:
placing a support substrate on a high-temperature boiler tube for conducting a chemical vapor deposition, a ferrocene is placed at an outside of a catalyst sublimation section;
injecting a carrier gas, under an environment of carrier gas, raise a temperature for a first catalyst growth section, a middle buffer section, and an end growth section of a high-temperature boiler tube;
pushing a ferrocene catalyst into a first catalyst growth section at a rising temperature, sublimating a ferrocene and injecting a process gas;
closing the carrier gas and leaving an argon gas and cooling to a room temperature, taking out a carbon nanotube forest; and
providing a first electrode and a second electrode to place above a grown same directory queue carbon nanotube forest, and contacting with a same directory queue carbon nanotube forest; and
using a protection encapsulation layer to package a first electrode, the second electrode, and the carbon nanotube forest, and a bottom back of the support substrate.

5. A sensing method for a carbon nanotube forest strain sensor with an encapsulation layer, comprising:
providing an object to be sensed;
putting a carbon nanotube forest strain sensor on the object to be sensed;
applying a small voltage to both electrodes of the carbon nanotube forest strain sensor, so that a support substrate producing a deformation; and
the carbon nanotube forest producing a resistance change rate, to form a sensing method of a carbon nanotube forest strain sensor with an encapsulation layer.
